(19) United States
(12) Patent Application Publication
(10) Pub. No.: US 2022/0118897 A1
(43) Pub. Date: Apr. 21, 2022

(54) FORWARD TILTING MECHANISM AND HEADREST INCLUDING THE SAME

(71) Applicants: HYUNDAI MOTOR COMPANY, Seoul (KR); KIA CORPORATION, Seoul (KR); SEOYONCNF, Ulsan (KR); HYUNDAI TRANSYS INC., Seosan-si (KR)

(72) Inventors: Tae Hoon Lee, Suwon-si (KR); Byeong Seon Son, Seoul (KR); Sang Ho Kim, Incheon (KR); Ji Hwan Kim, Seoul (KR); Seon Chae Na, Yongin-si (KR); Sang Hoon Park, Incheon (KR); Yong Jun Shin, Ulsan (KR); Jang Won Lee, Suwon-si (KR)

(73) Assignees: HYUNDAI MOTOR COMPANY, Seoul (KR); KIA CORPORATION, Seoul (KR); SEOYONCNF, Ulsan (KR); HYUNDAI TRANSYS INC., Seosan-si (KR)

(21) Appl. No.: 17/331,298

(22) Filed: May 26, 2021

(30) Foreign Application Priority Data
Oct. 16, 2020 (KR) 10-2020-0134139

(51) Int. Cl. B60N 2/853

(52) U.S. Cl. CPC B60N 2/853

(57) ABSTRACT

A forward tilting mechanism of a headrest for a vehicle and a headrest including the same are configured so that the headrest can be tilted forward in a simplified operating method. A forward tilting mechanism of a headrest includes: a fixing bracket mounted on a stay; a main body rotatably coupled to the fixing bracket; a driving part mounted on the fixing bracket between the fixing bracket and the main body; and a slider disposed between the driving part and the main body, and configured to be movable by operation of the driving part and configured to provide a moving force to the main body such that the main body is rotatable by the movement of the slider.

### CROSS-REFERENCE TO RELATED APPLICATION

The application claims priority to and the benefits of Korean Patent Application No. 10-2020-0134139, filed Oct. 16, 2020, which is hereby incorporated by reference in its entirety for all purposes.

### BACKGROUND

### Technical Field

The present disclosure relates to a tilting mechanism of a headrest for a vehicle and, more specifically, to a forward tilting mechanism and a headrest including the same, which are configured to have a headrest titled forward in a simplified operating method.

### Background Art

A seat of a vehicle includes various functions, such as a forward and rearward seat movement function, a seat cushion height adjustment function, and a lumbar support function of a backrest. These functions are designed to help a passenger adjust the seat according to the body characteristics of the passenger so that the passenger sits comfortably.

Further, the upper end of a seatback is installed with a headrest configured to support and protect the head and cervical spine of the passenger. In recent years, the headrest of the vehicle seat has been designed to have the angle of the headrest adjustable in addition to the height adjustment function for adjusting the headrest height according to the passenger's height when in use.

FIG. 1A illustrates such a tiltable headrest 600. A stay 601 mounted on a seatback of the vehicle is mounted with a fixing bracket 603. The fixing bracket 603 is fixed to the stay 601 to be not rotatable. A front-side frame 609 is configured to be movable with respect to the stay 601 through a plurality of links 605, 607 connected to the fixing bracket 603, such that the headrest 600 is tilted.

The fixing bracket 603 has a first hinge point 611. One side of a first link 605 is coupled to the fixing bracket 603 to be rotatable with respect to the first hinge point 611, and the other side of the first link 605 is coupled to the front-side frame 609. The first link 605 is coupled to one side of a second link 607. Therefore, rotation of any one of the first link 605 and the second link 607 enables rotation of the other one in conjunction therewith. The other side of the second link 607 has a second hinge point 613 and is coupled to the front-side frame 609 to be rotatable with respect to the front-side frame 609.

Further, the fixing bracket 603 is mounted with a motor 615 for powered adjustment. The motor 615 is coupled to a lead screw 617, and the lead screw 617 is configured to move the second link 607 by its linear movement. In other words, the second link 607 moves forward along a guide element 619 coupled to the fixing bracket 603. Then the front-side frame 609 rotates about the second hinge point 613. At the same time, the first link 605 connected to the second link 607 rotates about the first hinge point 611. The first link 605 is tilted and moves the front-side frame 609 forward with respect to a guide point 621. FIGS. 1B and 1C illustrate a state before tilting and a state after tilting, respectively.

This type of the headrest 600 includes a plurality of link structures, so the structure tends to be complex and the material costs and weight are high.

Another type of the headrest where the operating structure is arranged within the seatback other than the aforementioned headrest 600 has appeared. The operating structure of this type is included within the seatback rather than the headrest, so there is a disadvantage in that the operating range is limited. Also, the operating amount is determined within a range of the stay movement amount of the headrest.

The foregoing is intended merely to aid in understanding the background of the present disclosure, and is not intended to mean that the present disclosure falls within the purview of the related art that is already known to those having ordinary skill in the art.

### SUMMARY

Therefore, there is a need for the development of an improved tiltable headrest having a more simplified structure and no spatial constraint.

The present disclosure has thus been made in an effort to solve the above-described problems associated with the prior art.

It is an object of the present disclosure to provide a forward tilting mechanism and a headrest including the same, which can reduce material costs by incorporating a simplified tilting mechanism.

It is another object of the present disclosure to provide a forward tilting mechanism and a headrest including the same, which can reduce the number of components through a simplified tilting mechanism, thereby reducing the weight.

Still another object of the present disclosure is to provide a forward tilting mechanism and a headrest including the same, which can provide comfort to a passenger.

The objects of the present disclosure are not limited to those described above. Other unmentioned objects of the present disclosure should be more clearly understood by a person of ordinary skill in the art from the following description.

The features of the present disclosure to accomplish the objects of the present disclosure and to perform characteristic functions of the present disclosure are as follows.

In an aspect, a forward tilting mechanism of a headrest comprises: a fixing bracket mounted on a stay; a main body rotatably coupled to the fixing bracket; a driving part mounted on the fixing bracket between the fixing bracket and the main body; and a slider disposed between the driving part and the main body. The slider is configured to be movable by operation of the driving part and configured to provide a moving force to the main body such that the main body is rotatable by the movement of the slider.

In another aspect, a headrest comprises: a stay; a forward tilting mechanism including a fixing bracket mounted on a stay; a main body rotatably coupled to the fixing bracket; a driving part mounted on the fixing bracket between the fixing bracket and the main body; and a slider disposed between the driving part and the main body. The slider is configured to be movable by an operation of the driving part and configured to provide a moving force to the main body such that the main body is rotatable by the movement of the slider. The headrest also comprises a front cover coupled to the front of the main body and a rear cover coupled to the rear of the main body to accommodate the fixing bracket, the driving part, and the slider therein.

The present disclosure provides the forward tilting mechanism and the headrest including the same, which can reduce material costs by incorporating the simplified tilting mechanism.

The present disclosure proposes the forward tilting mechanism and the headrest including the same, which can reduce the number of components through the simplified tilting mechanism, thereby reducing the weight.

The present disclosure provides the forward tilting mechanism and the headrest including the same, which can provide comfort to the passenger.

Other aspects and embodiments of the present disclosure are discussed herein.

The above and other features of the disclosure are also discussed herein.

It should be understood that the term “vehicle” or “vehicular” or other similar term as used herein is inclusive of vehicles in general. Such vehicles may include motor vehicles such as: passenger automobiles including sports utility vehicles (SUVs), buses, trucks, and various commercial vehicles; watercraft including a variety of boats and ships; aircraft; and the like. Such vehicles may also include hybrid vehicles, electric vehicles, plug-in hybrid electric vehicles, hydrogen-powered vehicles, and other alternative fuel vehicles, e.g., fuels derived from resources other than petroleum. As referred to herein, a hybrid vehicle is a vehicle that has two or more sources of power, such as for example, vehicles that are both gasoline-powered and electric-powered.

### BRIEF DESCRIPTION OF THE DRAWINGS

FIG. 1A illustrates a power headrest as is known in the art.

FIG. 1B illustrates a pre-tilting operation state of the power headrest illustrated in FIG. 1A.

FIG. 1C illustrates a post-tilting operation state of the power headrest illustrated in FIG. 1A.

FIGS. 2A and 2B illustrate the states before and after the tilting operation of a headrest according to the present disclosure.

FIG. 3 illustrates an exploded perspective diagram of a forward tilting mechanism according to some embodiments of the present disclosure.

FIG. 4 illustrates a coupling state of some components of a forward tilting mechanism according to some embodiments of the present disclosure.

FIG. 5 illustrates a coupling state of some components of a forward tilting mechanism according to some embodiments of the present disclosure.

FIG. 6 illustrates an exploded perspective diagram of a headrest according to the present disclosure.

FIG. 7 illustrates a coupling state of some components of a headrest according to the present disclosure.

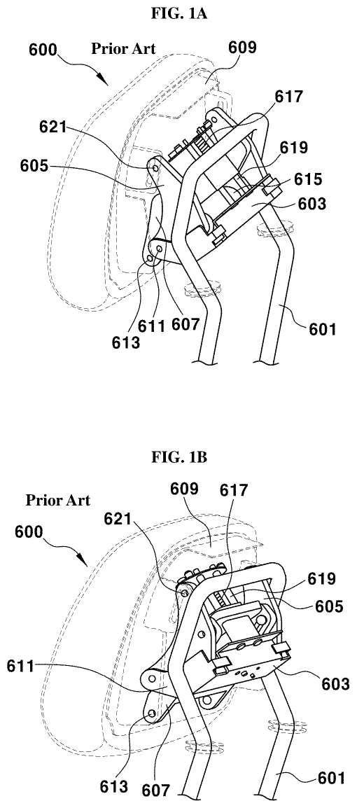

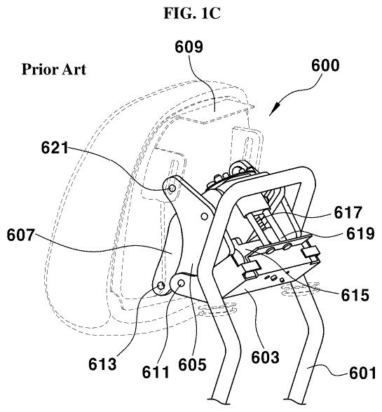

### DETAILED DESCRIPTION

Hereinafter, embodiments of the present disclosure are described in detail with reference to the accompanying drawings. Specific structures or functions described in the embodiments of the present disclosure are merely for illustrative purposes. Embodiments according to the concept of the present disclosure may be implemented in various forms. It should be understood that the concept should not be construed as being limited to the embodiments described in the present specification. The embodiments include all of modifications, equivalents, or substitutes included in the spirit and scope of the present disclosure.

It should be understood that, although the terms “first,” “second,” etc. may be used herein to describe various elements, these elements should not be limited by these terms. These terms are only used to distinguish one element from another element. For instance, a first element discussed below could be termed a second element without departing from the teachings of the present disclosure. Similarly, the second element could also be termed the first element.

It should be understood that, when an element is referred to as being “coupled” or “connected” to another element, it can be directly coupled or connected to the other element or intervening elements may be present therebetween. In contrast, it should be understood that, when an element is referred to as being “directly coupled” or “directly connected” to another element, there are no intervening elements present. Other expressions that explain the relationship between elements, such as “between,” “directly between,” “adjacent to,” or “directly adjacent to,” should be construed in the same way.

The same reference numerals denote identical or similar components throughout the specification. In the meantime, the terminology used herein is for the purpose of describing particular embodiments only and is not intended to be limiting. As used herein, the singular forms “a,” “an,” and “the” are intended to include the plural forms as well, unless the context clearly indicates otherwise. It should be further understood that the terms “comprise,” “include,” “have,” etc., when used in this specification, specify the presence of stated components, steps, operations, and/or elements, but do not preclude the presence or addition of one or more other components, steps, operations, and/or elements thereof.

Hereinafter, the present disclosure is described in detail with reference to the accompanying drawings.

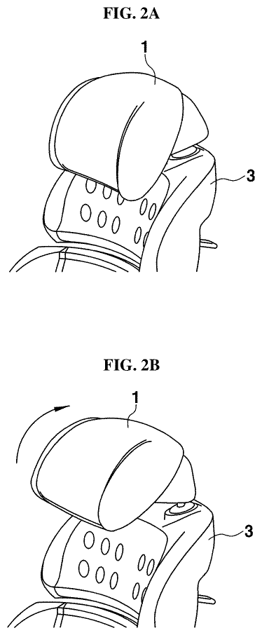

As illustrated in FIGS. 2A and 2B, a headrest 1 according to the present disclosure has a forward tilting mechanism operated by power. The headrest 1 according to the present disclosure is configured such that the headrest 1 may be slid or tilted forward easily and conveniently with respect to a seatback 3 by power, as indicated by the arrow illustrated in FIG. 2B, when a passenger of a seat lifts his/her head forward in a resting or sleeping posture.

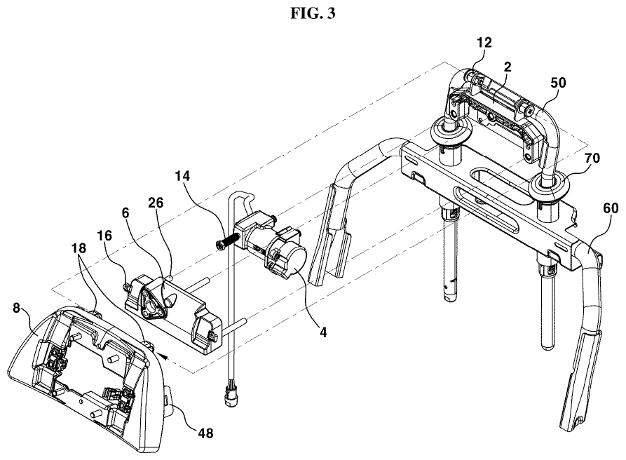

As illustrated in FIG. 3, the forward tilting mechanism according to the present disclosure includes a fixing bracket 2, a driving part 4, a slider 6, and a main body 8. In FIG. 3, the main body 8 side of the mechanism indicates a front side of the vehicle.

The fixing bracket 2 is mounted on a stay 50 of the headrest 1 for the vehicle. According to an embodiment of the present disclosure, both ends of the fixing bracket 2 may be coupled to the stay 50 and both ends of the fixing bracket 2 may be welded to the stay 50.

The fixing bracket 2 pivotably couples the main body 8. To this end, according to an embodiment of the present disclosure, the fixing bracket 2 has a cylindrical rod 12, and the main body 8 is rotatably coupled to the rod 12. The rod 12 is positioned on the upper portion of the fixing bracket 2 and may be configured such that the axial direction or longitudinal direction of the rod 12 is directed to the lateral direction of the fixing bracket 2.

According to an embodiment of the present disclosure, the fixing bracket 2 includes a plurality of through-holes 22. The through-holes 22 are spaced apart from each other to penetrate the fixing bracket 2 and are formed to penetrate the fixing bracket 2 in the front and rear direction of the fixing bracket 2.

The fixing bracket 2 is mounted with the driving part 4. The driving part 4 is configured to operate by power provided from an outside source. According to an embodiment of the present disclosure, the driving part 4 includes a motor. According to some embodiments of the present disclosure, the driving part 4 is coupled to a lead screw 14. The lead screw 14 is formed to be linearly movable by rotation of the driving part 4. According to some embodiments of the present disclosure, a rack and pinion may be operably coupled to the driving part 4 to replace the function of the lead screw 14.

The slider 6 is interposed between the driving part 4 and the main body 8. The slider 6 is configured to be movable by the movement of the lead screw 14. The lead screw 14 is in contact with the slider 6 when protruding from the driving part 4 by the driving part 4 to provide force pushing the slider 6. When the lead screw 14 retreats toward the drive part 4, the lead screw 14 ceases contacting the slider 6, and the slider 6 returns to the original location.

The slider 6 pushes the main body 8 when moved forward by the lead screw 14 and rotates the main body 8 to guide the rotation. To this end, according to an embodiment of the present disclosure, the slider 6 includes overhangs 16. The overhangs 16 are configured to protrude laterally outward from the sides of the slider 6. In one embodiment, a pair of overhangs 16 are formed on both sides of the slider 6, and the pair of overhangs 16 are configured to protrude from both sides of the slider 6. The overhang 16 is configured to be in contact with the main body 8 and slidable with respect to the main body 8 to provide the rotating force to the main body 8 and guide the rotation.

The movement of the slider 6 is guided by the fixing bracket 2. To this end, according to an embodiment of the present disclosure, the slider 6 includes a plurality of protrusions 26. The plurality of protrusions 26 are configured to be insertable into the through-holes 22. The plurality of protrusions 26 may be arranged at substantially the vertex locations of the triangle in the slider 6. Before the tilting operation, the protrusions 26 of the slider 6 are inserted into the through-hole 22, and during the tilting operation, the protrusions 26 are configured to be movable along the through-holes 22 to receive the guidance for the movement.

The main body 8 is coupled to the fixing bracket 2, and the slider 6 and the driving part 4 are disposed between the main body 8 and the fixing bracket 2. As described above, the main body 8 is pivotally coupled to the fixing bracket 2.

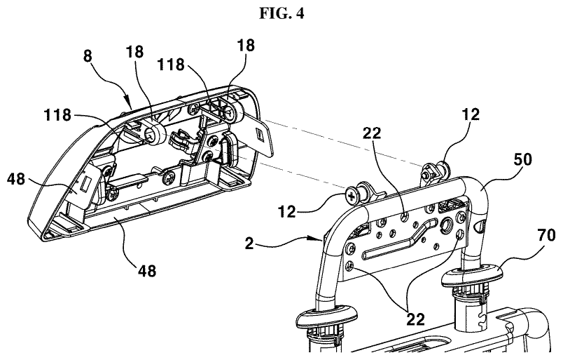

As illustrated in FIG. 4, to this end, according to an embodiment of the present disclosure, a link 18 is formed to extend from the surface of the main body 8 outwardly (i.e., the rearward) and is provided on the rear side of the main body 8. A pair of links 18 may be formed and the pair of links 18 may be disposed to be spaced apart from each other at a certain interval. Each of the pair of links 18 has a coupling hole 118. The coupling holes 118 of the respective links 18 are arranged to face each other. The coupling hole 118 serves as a hinge point of the main body 8, and the main body 8 is configured to rotate with respect to the coupling hole 118 to be tiltable upward.

In other words, the pair of links 18 is pivotably coupled to the fixing bracket 2. More specifically, the main body 8 is pivotably coupled to the fixing bracket 2 through the coupling holes 118 formed in the links 18. To this end, the fixing bracket 2 is provided with a pivot point. According to an embodiment of the present disclosure, the pivot point of the fixing bracket 2 may be the cylindrical rod 12 coupled to the fixing bracket 2. If the pair of links 18 are provided on the main body 8, the pair of rods 12 may be provided on the fixing bracket 2. In other words, each of the pair of rods 12 is inserted into each coupling hole 118, and each link 18 is configured to be rotatable with respect to the rod 12. In other words, the rod 12 is inserted into the coupling hole 118 such that the main body 8 is configured to be tiltable upward with respect to the rod 12.

Meanwhile, the main body 8 has one or more guide groove 28. The guide grooves 28 may be formed on the inner surfaces of both sides of the main body 8 and formed to be recessed from a portion protruding from the inner surface thereof. Further, the guide grooves 28 are formed substantially in the vertical direction and may be configured in a shape of an upside down U shape. The guide grooves 28 are configured to rotate the main body 8 in conjunction with the overhangs 16. In other words, before the titling, the overhangs 16 are disposed at the uppermost location of the guide grooves 28 and move downward along the guide grooves 28 when the tilting operation starts.

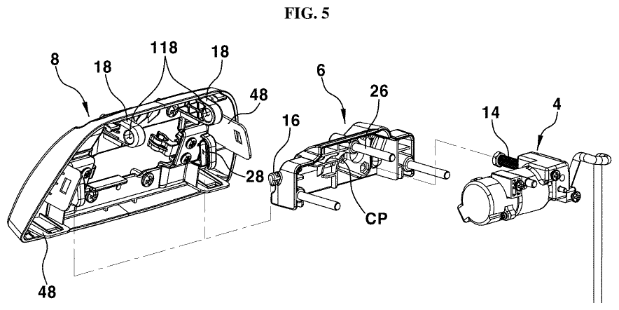

With reference to FIG. 5, the driving part 4 and the slider 6 are disposed between the main body 8 and the fixing bracket 2. More specifically, the main body 8 is disposed closer to the slider 6 than the fixing bracket 2, and the fixing bracket 2 is disposed closer to the driving part 4 than the main body 8. The slider 6 is moved by the driving of the driving part 4 and moves to lift the main body 8. At the same time, the main body 8 pivotally moves with respect to the fixing bracket 2 such that the headrest is tilted. More specifically, the driving part 4 moves the lead screw 14 toward the slider 6 for the tilting operation. The lead screw 14 is configured to push a contact point (CP), which is substantially the center portion of the slider 6. The overhangs 16 are movable within the guide groove 28 of the main body 8 and move downward from the uppermost location along the guide groove 28 when the slider 6 moves forward. At this time, the main body 8 is rotated with respect to the coupling holes 118 or the rod 12, which is the hinge point, and is tilted upward.

Further, the protrusions 26 are inserted into the fixing bracket 2 before the tilting operation and move along the through-holes 22 to guide the movement of the main body 8 when the slider 6 moves forward. In other words, the protrusion 26 serves to prevent the main body 8 from being twisted vertically or horizontally during the rotation.

Some embodiments of the present disclosure provide the headrest including the forward tilting mechanism.

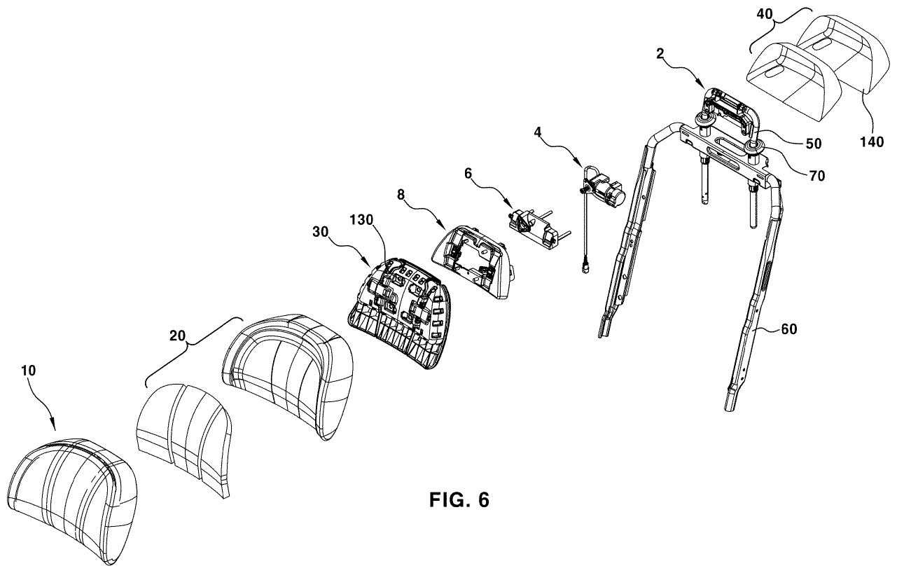

Referring to FIG. 6, the forward tilting mechanism is mounted on the headrest 1 of the vehicle and performs the forward tilting function of the headrest 1. The headrest 1 is mounted on the upper end of the seatback 3 (see FIGS. 2A and 2B) to support the head of the occupant. A seatback frame 60 forms the skeleton of the seatback 3 and is coupled to the stay 50 for mounting the headrest 1. The stay 50 is configured to be vertically movable with respect to the seatback 3. The seatback frame 60 may be provided with a pole guide 70 configured to guide the vertical movement of the stay 50 for the seatback frame 60.

As described above, the fixing bracket 2 is mounted on the stay 50. The main body 8 is rotatably coupled to the fixing bracket 2 with the driving part 4 and the slider 6 interposed therebetween. Since the above descriptions can be applied hereto, repeating the description has been omitted.

A front cover 30 is coupled to the front of the main body 8. The front cover 30 serves as the skeleton supporting the entire shape of the headrest 1 and is surrounded by a pad 20 and an outer cover 10.

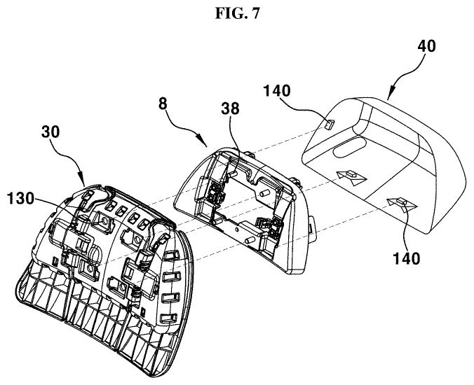

As illustrated in FIG. 7, the front cover 30 may comprise one or more coupling parts 130. The coupling parts 130 are formed for coupling with the main body 8. As a non-limiting example, the coupling parts 130 may be holes penetrating the front cover 30. According to an embodiment of the present disclosure, the front side surface of the main body 8 has a plurality of projections 38 protruding from the surface. The plurality of projections 38 are configured to be coupled to the coupling part 130, such as for example, fitted into and coupled to the coupling part 130 configured as the hole.

A rear cover 40 accommodates the forward driving mechanism therein from the rear of the stay 50 and is coupled to the main body 8. To this end, according to an embodiment of the present disclosure, the rear cover 40 includes a plurality of engagements 140, and the main body 8 is formed with a plurality of hooks 48. The hooks 48 may be formed on the left and right and lower sides of the main body 8, and the engagements 140 may be formed on the rear cover 40 at positions corresponding to the hooks 48. The main body 8 and the rear cover 40 are coupled by coupling the hooks 48 and the engagements 140.

As described above, the present disclosure can simplify the angle adjustment mechanism of the headrest compared to existing headrests, thereby greatly reducing the material cost.

Further, the present disclosure can reduce the number of components by simplifying the structure, thereby reducing the overall weight.

Considering the trends where various functions have been added to vehicle seats (e.g., healthcare, heart rate measurement device, massage device, or the like), the tilting mechanism does not have to be installed within the seatback according to the present disclosure, thereby providing more space and further improving the applicability of other functions.

Further, the present disclosure can allow the lower end of the headrest to support a passenger's neck, thereby allowing the passenger to board the vehicle and sit with a comfortable posture.

It should be understood that the present disclosure is not limited to the above described embodiments and the accompanying drawings. Various substitutions, modifications, and alterations can be devised by those having ordinary skill in the art without departing from the technical spirit of the present disclosure.

What is claimed is:

1. A forward tilting mechanism of a headrest, the forward tilting mechanism comprising:
a fixing bracket mounted on a stay;
a main body rotatably coupled to the fixing bracket;
a driving part mounted on the fixing bracket between the fixing bracket and the main body; and
a slider disposed between the driving part and the main body and configured to be movable by operation of the driving part and to provide moving force to the main body such that the main body is rotatable by the movement of the slider.

2. The forward tilting mechanism of claim 1,
wherein the fixing bracket comprises a rod formed in an upper portion of the fixing bracket and rotationally coupling the main body, wherein an axial direction of the rod is aligned with a lateral direction of the fixing bracket.

3. The forward tilting mechanism of claim 2,
wherein the main body comprises a link protruding toward the fixing bracket and rotatably coupled to the rod.

4. The forward tilting mechanism of claim 3,
wherein the link has a coupling hole penetrating the link and configured to have the rod inserted therein.

5. The forward tilting mechanism of claim 4,
wherein the main body rotates with respect to the coupling hole to be titled upward.

6. The forward tilting mechanism of claim 4,
wherein the link is configured to rotate with respect to the rod to have the main body tiltable upward.

7. The forward tilting mechanism of claim 1,
wherein the driving part comprises a lead screw configured to be linearly movable toward the slider or in a direction away from the slider by operation of the driving part.

8. The forward tilting mechanism of claim 1,
wherein the slider comprises a pair of overhangs protruding from both sides to the laterally outward, respectively, and configured to be slidable on the main body.

9. The forward tilting mechanism of claim 8,
wherein the main body comprises a guide groove formed in the surface of the inner surface thereof and forming a path through which the overhang is slidable.

10. The forward tilting mechanism of claim 1,
wherein the slider comprises a plurality of protrusions insertable into the fixing bracket and protruding from the surface thereof.

11. The forward tilting mechanism of claim 10,
wherein the fixing bracket comprises a plurality of through-holes into which the protrusions are insertable, and wherein the protrusion is configured to be movable with respect to the through-hole.

12. The forward tilting mechanism of claim 11,
wherein the slider is configured to be linearly movable in the direction away from the driving part or toward the driving part by the operation of the driving part, and
wherein the protrusion is configured to move with respect to the through-hole according to the operation of the driving part.

13. The forward tilting mechanism of claim 1, further comprising a rack and pinion operated in conjunction with the driving part and configured such that the slider is linearly movable toward the driving part and/or in the direction away from the driving part.

14. A headrest comprising:
a stay;
a forward tilting mechanism including a fixing bracket mounted on a stay; a main body rotatably coupled to the fixing bracket; a driving part mounted on the fixing bracket between the fixing bracket and the main body; and a slider disposed between the driving part and the main body and configured to be movable by operation of the driving part and to provide moving force to the main body such that the main body is rotatable by the movement of the slider;
a front cover coupled to the front of the main body; and
a rear cover coupled to the rear of the main body to accommodate the fixing bracket, the driving part, and the slider therein.

15. The headrest of claim 14,
wherein the front side surface of the main body is formed with a plurality of projections protruding therefrom.

16. The headrest of claim 15,
wherein the front cover comprises a plurality of coupling parts penetrating the front cover and having the plurality of projections inserted therein.

17. The headrest of claim 14,
wherein a plurality of hooks are provided on the rear side of the main body and the rear cover is formed with a plurality of engagements couplable to the plurality of hooks.
